(19) United States
(12) Patent Application Publication
(10) Pub. No.: US 2026/0355548 A1
(43) Pub. Date: Nov. 12, 2026

(54) BREATHING DEVICE AND METHOD FOR CONTROLLING AIRFLOW UNIT OF BREATHING DEVICE

(71) Applicant: 3M INNOVATIVE PROPERTIES COMPANY, St. Paul, MN (US)

(72) Inventors: Michael L. Parham, Marine on St. Croix, MN (US); Paul A. Martinson, Maplewood, MN (US); James F. Poch, New Richmond, WI (US); Douglas D. Jensen, Woodbury, MN (US)

(21) Appl. No.: 19/134,415

(22) PCT Filed: Nov. 30, 2023
(86) PCT No.: PCT/IB2023/062091

§ 371 Date: May 30, 2025

Related U.S. Application Data
(60) Provisional application No. 63/385,634, filed on Dec. 1, 2022.

(51) Int. Cl. A62B 7/12; A62B 7/10; A62B 9/00; A62B 18/00; A62B 18/08

(52) U.S. Cl. CPC A62B 7/12; A62B 7/10; A62B 9/00; A62B 18/006; A62B 18/088

(57) ABSTRACT

A breathing device includes an airflow unit configured to provide a respiratory airflow, a respiratory interface fluidly coupled to the airflow unit, at least one pressure sensor configured to generate at least one signal, and a controller communicably coupled to the airflow unit and the at least one pressure sensor. The respiratory interface is configured to supply the respiratory airflow to a user. The respiratory interface includes a respiratory inlet configured to receive the respiratory airflow from the airflow unit. The at least one pressure sensor is disposed at the respiratory inlet. The controller is configured to: determine a respiratory inlet pressure based on the at least one signal; determine a target airflow rate based at least on the respiratory inlet pressure; and control the airflow unit based on the target airflow rate, such that the airflow unit provides the respiratory airflow at the target airflow rate.

### TECHNICAL FIELD

The present disclosure generally relates to a breathing device including an airflow unit and a method for controlling the airflow unit of the breathing device.

### BACKGROUND

A respiratory device is typically used to provide breathing air to a worker in dirty or contaminated work environments where there is known to be, or there is a risk of dusts, fumes, or gases that are potentially hazardous or harmful to the health of the worker. The breathing air is provided to a breathing zone (an area around nose and mouth, known as the orinasal area) of the worker via a respiratory interface. The breathing air is provided by an air unit. The flow of the breathable air supplied at the respiratory interface is based on the breathing air provided by the air unit.

Generally, the air unit is controlled by a control unit which uses complex methods and algorithms to maintain a positive pressure at the respiratory interface relative to an ambient pressure. In some applications, the air unit must rapidly increase the flow of the breathable air to maintain the positive pressure at the respiratory interface relative to the ambient pressure. In some cases, non-braking fans/drive electronics and/or secondary airways (air bladders) with valves are used to rapidly increase the flow of the breathable air to improve a response time of the air unit. However, the secondary airways may further increase size and complexity of the respiratory device. Further, rapid ramping of the drive electronics may concern/bother an end user, such as the worker. For example, pulsating sounds and pressure waves may cause a nuisance to the end user. In addition, only certain types of respiratory interfaces, e.g., tight fitting respiratory interfaces, may be compatible with such respiratory devices to provide relative pressure changes corresponding to rapid changes in the flow of the breathable air.

### SUMMARY

In a first aspect, the present disclosure provides a breathing device. The breathing device includes an airflow unit configured to provide a respiratory airflow. The breathing device further includes a respiratory interface fluidly coupled to the airflow unit and configured to supply the respiratory airflow to a user of the breathing device. The respiratory interface includes a respiratory inlet configured to receive the respiratory airflow from the airflow unit. The breathing device further includes at least one pressure sensor configured to generate at least one signal. The at least one pressure sensor is disposed at the respiratory inlet. The breathing device further includes a controller communicably coupled to each of the airflow unit and the at least one pressure sensor. The controller is configured to receive the at least one signal from the at least one pressure sensor. The controller is further configured to determine a respiratory inlet pressure based on the at least one signal received from the at least one pressure sensor. The controller is further configured to determine a target airflow rate based at least on the respiratory inlet pressure. The controller is further configured to control the airflow unit based on the target airflow rate, such that the airflow unit provides the respiratory airflow at the target airflow rate.

In a second aspect, the present disclosure provides a breathing device. The breathing device includes an airflow unit configured to provide a respiratory airflow. The breathing device further includes a respiratory interface fluidly coupled to the airflow unit and configured to supply the respiratory airflow to a user of the breathing device. The breathing device further includes a controller communicatively coupled to the airflow unit. The controller configured to receive at least one sensor signal including at least one sensor parameter. The controller is further configured to determine a target airflow rate at least based on the at least one sensor parameter. The controller is further configured to control the airflow unit based on the target airflow rate, such that the airflow unit provides the respiratory airflow at the target airflow rate.

In a third aspect, the present disclosure provides a method for controlling an airflow unit of a breathing device. The method includes receiving at least one signal from at least one pressure sensor disposed at a respiratory inlet. The method further includes determining a respiratory inlet pressure based on the at least one signal received from the at least one pressure sensor. The method further includes determining a target airflow rate based at least on the respiratory inlet pressure. The method further includes controlling the airflow unit based on the target airflow rate, such that the airflow unit provides a respiratory airflow at the target airflow rate.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic diagram of a breathing device and a user of the breathing device, according to an embodiment of the present disclosure;

FIG. 2 is a schematic block diagram of the breathing device, according to an embodiment of the present disclosure;

FIG. 3A is a schematic block diagram of an airflow unit of the breathing device, according to an embodiment of the present disclosure;

FIG. 3B is a schematic block diagram of an airflow unit of the breathing device, according to another embodiment of the present disclosure;

FIGS. 4A-4B are detailed schematic block diagrams of the breathing device, according to an embodiment of the present disclosure;

FIGS. 5A-5B are schematic block diagrams of a controller of the breathing device, according to an embodiment of the present disclosure;

FIG. 5C is an exemplary plot depicting pressure versus time for the breathing device;

FIG. 6A is an exemplary plot depicting a relationship between an airflow rate of the airflow unit and a static pressure of a respiratory interface;

FIG. 6B is a detailed schematic block diagram of the breathing device, according to an embodiment of the present disclosure;

FIG. 7 is a detailed schematic block diagram of the breathing device, according to an embodiment of the present disclosure;

FIG. 8 is a detailed schematic block diagram of the breathing device, according to an embodiment of the present disclosure;

FIG. 9 is an exemplary plot depicting at least one battery parameter versus time for a battery pack of the breathing device;

FIG. 10 is a detailed schematic block diagram of the breathing device, according to an embodiment of the present disclosure;

FIG. 11 is an exemplary plot depicting at least one filter parameter versus time for at least one filter of the breathing device;

FIG. 12 is a detailed schematic block diagram of the breathing device, according to an embodiment of the present disclosure;

FIG. 13 is a detailed schematic block diagram of the breathing device, according to an embodiment of the present disclosure;

FIG. 14 is a schematic block diagram of a breathing device, according to another embodiment of the present disclosure;

FIGS. 15A-15B are detailed schematic block diagrams of the breathing device, according to an embodiment of the present disclosure;

FIG. 16 is a detailed schematic block diagram of the breathing device, according to an embodiment of the present disclosure;

FIG. 17 is a detailed schematic block diagram of the breathing device, according to an embodiment of the present disclosure;

FIG. 18 is a detailed schematic block diagram of the breathing device, according to an embodiment of the present disclosure;

FIG. 19 is a detailed schematic block diagram of the breathing device, according to an embodiment of the present disclosure; and

FIG. 20 is a flowchart for a method for controlling the airflow unit of the breathing device, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20 % for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

Terms such as same, equal, uniform, constant, strictly, and the like, are understood to be within the usual tolerances or measuring error applicable to the particular circumstance rather than requiring absolute precision or a perfect match.

As used herein, “at least one of A and B” should be understood to mean “only A, only B, or both A and B”.

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “communicably coupled to” refers to direct coupling between components and/or indirect coupling between components via one or more intervening components. Such components and intervening components may comprise, but are not limited to, junctions, communication paths, components, circuit elements, circuits, functional blocks, and/or devices. As an example of indirect coupling, a signal conveyed from a first component to a second component may be modified by one or more intervening components by modifying the form, nature, or format of information in a signal, while one or more elements of the information in the signal are nevertheless conveyed in a manner than can be recognized by the second component.

As used herein, the term “signal,” includes, but is not limited to, one or more electrical signals, optical signals, electromagnetic signals, analog and/or digital signals, one or more computer instructions, a bit and/or bit stream, or the like.

As used herein, the term “microphone” refers to a transducer or sensor that converts sound into an electrical audio signal.

As used herein, the term “hazardous or potentially hazardous environments” may refer to environments that include hazardous or potentially hazardous environmental conditions. The hazardous or potentially hazardous environments may include, for example, fires, chemical environments, biological environments, nuclear environments, industrial sites, construction sites, agricultural sites, mining sites, or manufacturing sites.

As used herein, the term “airflow rate” may refer to a volume or mass of breathable gas passing through a device in a given time.

As used herein, the terms “responder” or “emergency responder” refer to any person or persons responsible for addressing an emergency situation, such as firefighters, first responders, healthcare professionals, paramedics, HAZMAT workers, security personnel, law enforcement personnel, or any other personnel working in the hazardous environment.

Various respiratory devices may be used by a user entering a hazardous environment having harmful conditions (e.g., air contaminated with harmful substances, such as, airborne particulates, toxic fumes, smoke, vapors, etc.). The respiratory devices may provide clean and respirable air to the user. In some cases, the respiratory devices may provide a forced flow of respirable air to the user via a blower. In some cases, the respiratory devices may provide the clean and respirable air to the user from another source, such as an air tank. Examples of the respiratory devices include powered air purifying respirators (PAPR) and supplied-air respirators, such as self-contained breathing apparatus (SCBA), or a supplied air pipe-line and pressure regulator and controllable breathing valve.

The respirable air is provided to a breathing zone (an area around nose and mouth, known as the orinasal area) of the user via a respiratory interface. The respirable air is provided by an air unit (e.g., the blower or the air tank). The flow of the respirable air supplied at the respiratory interface is based on the respirable air provided by the air unit. Typically, the air unit is controlled by a controller which uses complex methods and algorithms to maintain a positive pressure at the respiratory interface relative to the ambient pressure. In some applications, the air unit must rapidly increase the flow of the respirable air to maintain the positive pressure at the respiratory interface relative to the ambient pressure. In some cases, non-braking fans/drive electronics and/or secondary airways (air bladders) with valves are used to rapidly increase the flow of the respirable air to improve a response time of the air unit. However, the secondary airways may further increase size and complexity of the respiratory devices. Moreover, rapid ramping of the drive electronics may concern/bother an end user, such as the user. In addition, only certain types of respiratory interfaces, e.g., tight fitting respiratory interfaces, may be compatible with such respiratory devices to provide relative pressure changes corresponding to rapid changes in the flow of the respirable air.

According to aspects of this disclosure, a breathing device, and a method for controlling an airflow unit of the breathing device are disclosed.

The breathing device includes the airflow unit configured to provide a respiratory airflow. The breathing device further includes a respiratory interface fluidly coupled to the airflow unit and configured to supply the respiratory airflow to a user of the breathing device. The respiratory interface includes a respiratory inlet configured to receive the respiratory airflow from the airflow unit. The breathing device further includes at least one pressure sensor configured to generate at least one signal. The at least one pressure sensor is disposed at the respiratory inlet. The breathing device further includes a controller communicably coupled to each of the airflow unit and the at least one pressure sensor. The controller is configured to receive the at least one signal from the at least one pressure sensor. The controller is further configured to determine a respiratory inlet pressure based on the at least one signal received from the at least one pressure sensor. The controller is further configured to determine a target airflow rate based at least on the respiratory inlet pressure. The controller is further configured to control the airflow unit based on the target airflow rate, such that the airflow unit provides the respiratory airflow at the target airflow rate.

Since the controller is configured to determine the target airflow rate based at least on the respiratory inlet pressure and control the airflow unit based on the target airflow rate, such that the airflow unit provides the respiratory airflow at the target airflow rate, there may not be a requirement to rapidly increase the respiratory airflow to maintain the positive pressure relative to the ambient pressure. In contrast, the airflow unit may provide the respiratory airflow based on at least on the respiratory inlet pressure, which may or may not be the positive pressure relative to the ambient pressure. This may minimize and/or optimize the respiratory airflow and may therefore eliminate a need to rapidly increase the respiratory airflow. Thus, complex airways, valves, and/or drive mechanisms may not be required which may otherwise further increase size and/or cost of the breathing device. Moreover, any type of suitable respiratory inlet (e.g., tight fitting, loose fitting, full mask, and/or half mask) may be used with the breathing device according to the present disclosure.

The controller may determine the target airflow rate based on a predetermined relationship between the target airflow rate and a sensed parameter (e.g., the respiratory inlet pressure). The predetermined relationship may include, for example, but not limited to, a lookup table, a mathematical equation (e.g., a multiple polynomial regression model), a physics-based model, a neural network model, or any other model or algorithm known in the art.

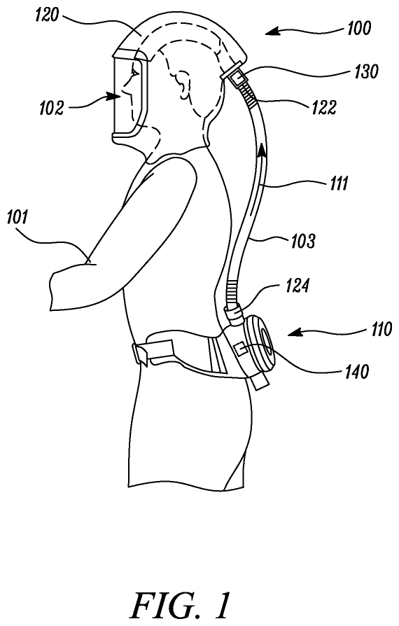

FIG. 1 illustrates a schematic diagram of a breathing device 100 and a user 101 of the breathing device 100, according to an embodiment of the present disclosure. In some embodiments, the user 101 may be an emergency responder. The user 101 may use the breathing device 100 in a hazardous or potentially hazardous environment.

In the illustrated embodiment of FIG. 1, the breathing device 100 is a powered air purifying respirator (PAPR). However, in some other embodiments, the breathing device 100 may include supplied-air respirators, for example, self-contained breathing apparatus (SCBA).

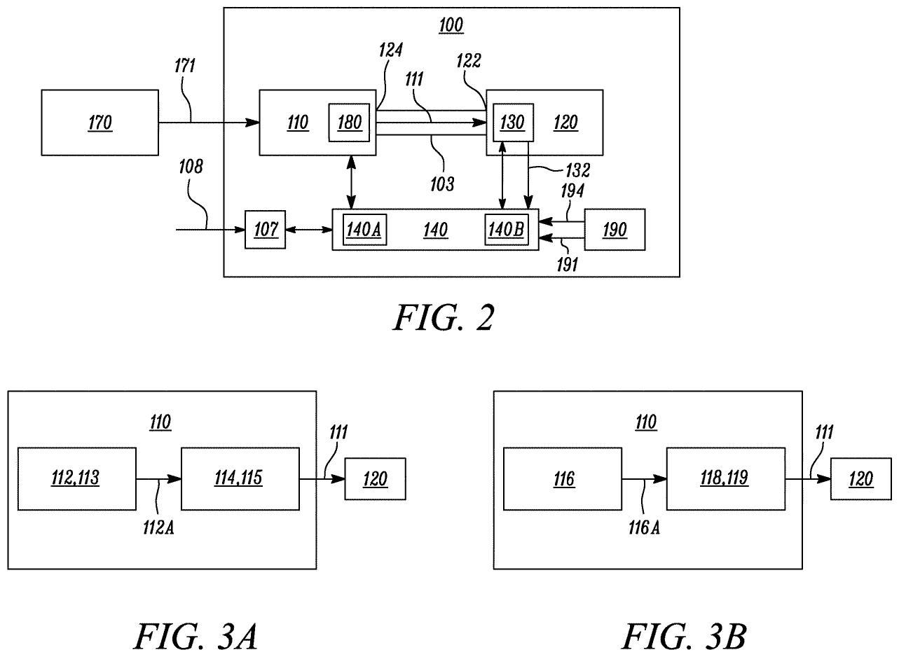

FIG. 2 illustrates a schematic block diagram of the breathing device 100, according to an embodiment of the present disclosure.

Referring to FIGS. 1 and 2, the breathing device 100 includes an airflow unit 110 configured to provide a respiratory airflow 111. In some embodiments, the airflow unit 110 is configured to provide the respiratory airflow 111 through an outlet 124 of the airflow unit 110.

The breathing device 100 further includes a respiratory interface 120 fluidly coupled to the airflow unit 110 and configured to supply the respiratory airflow 111 to the user 101 of the breathing device 100. Specifically, the respiratory interface 120 is configured to supply the respiratory airflow 111 to a breathing zone 102 (an area around nose and mouth, known as an orinasal area) of the user 101. The respiratory interface 120 is typically worn on a head/face of the user 101 and at least partially encloses the head/face to form the breathing zone 102, so that the respiratory airflow 111 is directed to the breathing zone 102. In some embodiments, the respiratory interface 120 includes a head piece or a face piece. In some embodiments, the respiratory interface 120 includes a tight fitting or a loose fitting head/face piece. In some embodiments, the respiratory interface 120 includes a half mask or a full mask. In the illustrated embodiment of FIG. 1, the respiratory interface 120 includes a hood.

The respiratory interface 120 includes a respiratory inlet 122 configured to receive the respiratory airflow 111 from the airflow unit 110. In some embodiments, the airflow unit 110 supplies respiratory airflow 111 to the respiratory interface 120 through a tube 103 connected between the respiratory inlet 122 of the respiratory interface 120 and the outlet 124 of the airflow unit 110.

The breathing device 100 further includes at least one pressure sensor 130 configured to generate at least one signal 132. The at least one pressure sensor 130 is disposed at the respiratory inlet 122. Thus, the at least one pressure sensor 130 is configured to generate the at least one signal 132 indicative of a pressure at the respiratory inlet 122.

The breathing device 100 further includes a controller 140. In some embodiments, the controller 140 may be arranged inside the airflow unit 110. In some other embodiments, the controller 140 may be arranged outside the airflow unit 110.

In some embodiments, the controller 140 may include any suitable type of processing circuitry, such as one or more general-purpose controller or microcontroller or processors (e.g., ARM-based processors, Neural Network (NN) processors, etc.), a Digital Signal Processor (DSP), a Programmable Logic Device (PLD), an Application-Specific Integrated Circuit (ASIC), a Field-Programmable Gate Array (FPGA), etc.

In some embodiments, the controller 140 includes a memory 140A. The memory 140A may include a random access memory (RAM), a read-only memory ROM, an electrically programmable read-only memory (EPROM), an electrically erasable and programmable read-only memory (EEPROM), a compact disc-read-only memory (CD-ROM), other optical disk storage, a magnetic disk storage, other magnetic storage devices, a flash memory, or any other medium that can be used to store a computer program in the form of instructions or data structures that can be accessed by the controller 140.

The memory 140A may store the computer program that is executed by the controller 140. The memory 140A may further store information that may be used by the controller 140 during the operation of the breathing device 100. In some embodiments, the controller 140 may further include a transceiver 140B.

The controller 140 is communicably coupled to each of the airflow unit 110 and the at least one pressure sensor 130. The controller 140 is configured to receive the at least one signal 132 from the at least one pressure sensor 130. In some embodiments, the controller 140 is configured to receive the at least one signal 132 from the at least one pressure sensor 130 via the transceiver 140B.

In some embodiments, the breathing device 100 further includes at least one filter 180 mounted to the airflow unit 110 and configured to filter the respiratory airflow 111.

In some embodiments, the at least one filter 180 may be at least one particulate filter. In some embodiments, the at least one filter 180 may be at least one gas/vapor filter. In some embodiments, the at least one filter 180 may include multiple filters. In some embodiments, some of the multiple filters may be particulate filters and the others may be gas/vapor filters.

In some embodiments, the breathing device 100 further includes at least one microphone 190 configured to generate a speech signal 194. In some embodiments, the at least one microphone 190 is mounted proximal to the respiratory interface 120. In some embodiments, the at least one microphone 190 may be mounted inside the respiratory interface 120. In some other embodiments, the at least one microphone 190 may be mounted outside the respiratory interface 120. In some embodiments, the at least one microphone 190 may include multiple microphones. In some embodiments, some of the multiple microphones may be mounted inside the respiratory interface 120 and the others may be mounted outside the respiratory interface 120.

The at least one microphone 190 may receive mechanical vibrations from a speech of the user 101 and may convert the mechanical vibrations into electric audio signals, i.e., the speech signal 194. In some examples, the speech signal 194 corresponds to the speech of the user 101, and a noise signal 191 indicative of other sounds, such as a noise internal or external to the respiratory interface 120. In some embodiments, the noise is caused by the airflow unit 110.

In some embodiments, a battery pack 170 is electrically coupled to at least the airflow unit 110 and configured to provide an electric power 171 to at least the airflow unit 110. In some embodiments, the battery pack 170 is electrically coupled to the breathing device 100 and configured to provide the electric power 171 to at least the airflow unit 110. In some embodiments, the battery pack 170 may be configured to provide the electric power 171 to other components of the breathing device 100, for example, the at least one pressure sensor 130 and/or the controller 140. In some embodiments, the breathing device 100 includes the battery pack 170.

The battery pack 170 includes one or more primary cells and/or one or more secondary cells. In some embodiments, the one or more secondary cells include rechargeable cells, for example nickel metal hydride (NiMH) or lithium ion (Li-ion) cells that may be suitable for powering at least the airflow unit 110 and may have sufficient power capacity to also provide the electric power 171 to the at least one pressure sensor 130 and/or the controller 140. In some embodiments, the one or more primary cells include dry cells that may be used and be replaced when their power has been depleted.

In some embodiments, the breathing device 100 includes one or more input devices 107 communicably coupled to the controller 140. The one or more input devices 107 may be configured to receive a user input 108 from the user 101. In some examples, the one or more input devices 107 include a mouse, a keyboard, a touch-sensitive screen, a voice responsive system, a video camera, a button, a control pad, a microphone, or any other type of input devices for detecting the user input 108 from the user 101.

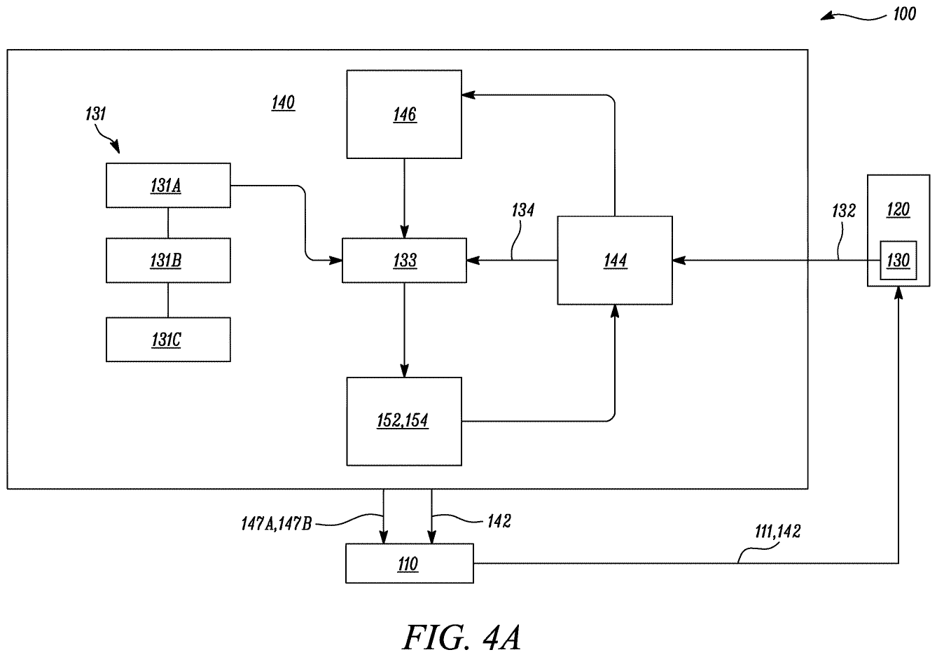

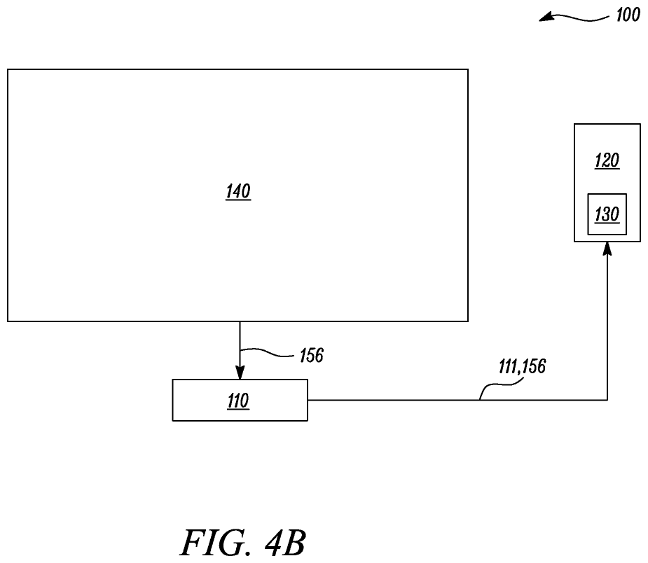

FIG. 3A illustrates a schematic block diagram of the airflow unit 110 of the breathing device 100 shown in FIG. 2, according to an embodiment of the present disclosure. In some embodiments, the airflow unit 110 includes a motor 112 and a blower 114. The blower 114 is fluidly coupled to the respiratory interface 120. In some embodiments, the blower 114 is a PAPR blower. The motor 112 is mechanically coupled to the blower 114 and provides a mechanical power 112A to the blower 114. The motor 112 drives the blower 114 which generates the respiratory airflow 111 provided by the airflow unit 110.

FIG. 3B illustrates a schematic block diagram of the airflow unit 110 of the breathing device 100 shown in FIG. 2, according to another embodiment of the present disclosure. In some embodiments, the airflow unit 110 includes an air source 116 and a valve 118. The air source 116 is fluidly coupled to the valve 118. Further, the valve 118 is fluidly coupled to the respiratory interface 120. In some embodiments, the valve 118 is a supplied air respirator valve. The valve 118 controls a flow of a pressurized air 116A from the air source 116 which generates the respiratory airflow 111 provided by the airflow unit 110.

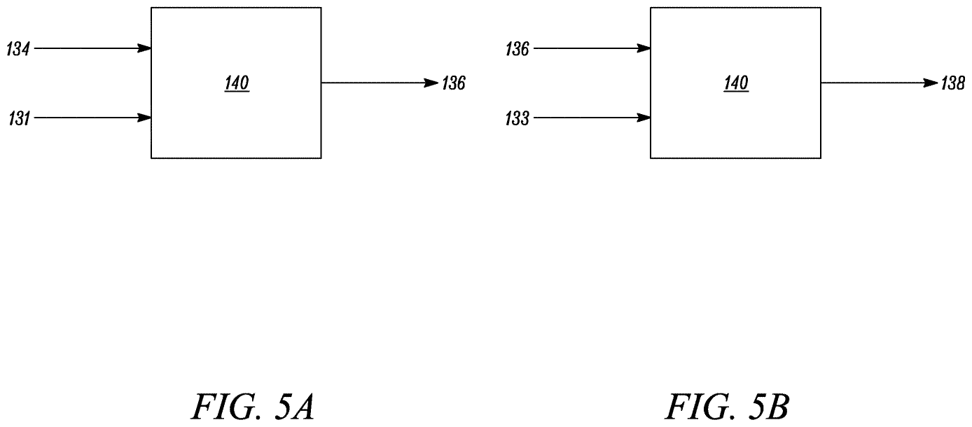

FIGS. 4A and 4B illustrate detailed schematic block diagrams of the breathing device 100, according to an embodiment of the present disclosure.

Referring to FIG. 4A, the controller 140 is configured to determine a respiratory inlet pressure 134 based on the at least one signal 132 received from the at least one pressure sensor 130. The controller 140 is further configured to determine a target airflow rate 142 based at least on the respiratory inlet pressure 134. The controller 140 may determine the target airflow rate 142 based on a predetermined relationship between the target airflow rate 142 and the respiratory inlet pressure 134. The predetermined relationship may include, for example, but not limited to, a lookup table, a mathematical equation (e.g., a multiple polynomial regression model), a physics-based model, a neural network model, or any other model or algorithm known in the art.

The controller 140 is further configured to control the airflow unit 110 based on the target airflow rate 142, such that the airflow unit 110 provides the respiratory airflow 111 at the target airflow rate 142. Referring to FIGS. 3A and 4A, in some embodiments, the controller 140 is further configured to control at least one of a motor parameter 113 of the motor 112 and a blower parameter 115 of the blower 114 to achieve the target airflow rate 142. In some embodiments, the motor parameter 113 includes a current and/or a voltage. The current and/or voltage may further control the mechanical power 112A provided to the blower 114. In some embodiments, the blower parameter 115 may include a speed of a fan of the blower 114.

Referring to FIGS. 3B and 4A, in some embodiments, the controller 140 is further configured to control a valve parameter 119 of the valve 118 to achieve the target airflow rate 142. In some embodiments, the valve parameter 119 may include a size of an opening of the valve 118.

Referring again to FIGS. 4A and 4B, in some embodiments, the controller 140 is further configured to determine a pressure parameter 144 over a predetermined time period based on the at least one signal 132. In some embodiments, the controller 140 is further configured to determine the respiratory inlet pressure 134 based on the pressure parameter 144. In some embodiments, the pressure parameter 144 includes one of an average pressure, a minimum peak pressure, and a maximum peak pressure. Therefore, the pressure parameter 144 may further reduce a requirement of a rapid increase or decrease of the target airflow rate 142, which may optimize the operation of the airflow unit 110.

In some embodiments, the controller 140 is further configured to determine a breathing rate 146 of the user 101 (shown in FIG. 1) based on the pressure parameter 144. In some embodiments, the controller 140 is further configured to switch on the airflow unit 110 upon determining that the breathing rate 146 is indicative of breathing of the user 101. In some embodiments, the controller 140 may be configured to generate one or more signals 147A upon determining the breathing rate 146 is indicative of breathing of the user 101. The controller 140 may further transmit the one or more signals 147A to the airflow unit 110 to switch on the airflow unit 110.

In some embodiments, the controller 140 is further configured to switch off the airflow unit 110 upon determining that the breathing rate 146 is not indicative of breathing of the user 101. In some embodiments, the controller 140 may be configured to generate one or more signals 147B upon determining that the breathing rate 146 is not indicative of breathing of the user 101. The controller 140 may further transmit the one or more signals 147B to the airflow unit 110 to switch off the airflow unit 110.

In some other embodiments, the user 101 may switch on or switch off the airflow unit 110 via the one or more input devices 107 (shown in FIG. 2).

Referring to FIG. 4B, in some embodiments, if the controller 140 does not receive the at least one signal 132 from the at least one pressure sensor 130, the controller 140 is further configured to control the airflow unit 110 to provide a predetermined airflow rate 156. In some embodiments, the predetermined airflow rate 156 may be based on a preset and/or a user setting stored in the memory 140A (shown in FIG. 2). In some embodiments, the predetermined airflow rate 156 may be based on a maximum airflow rate of the airflow unit 110. In some embodiments, if the controller 140 does not receive the at least one signal 132 from the at least one pressure sensor 130, the controller 140 may generate an alarm signal.

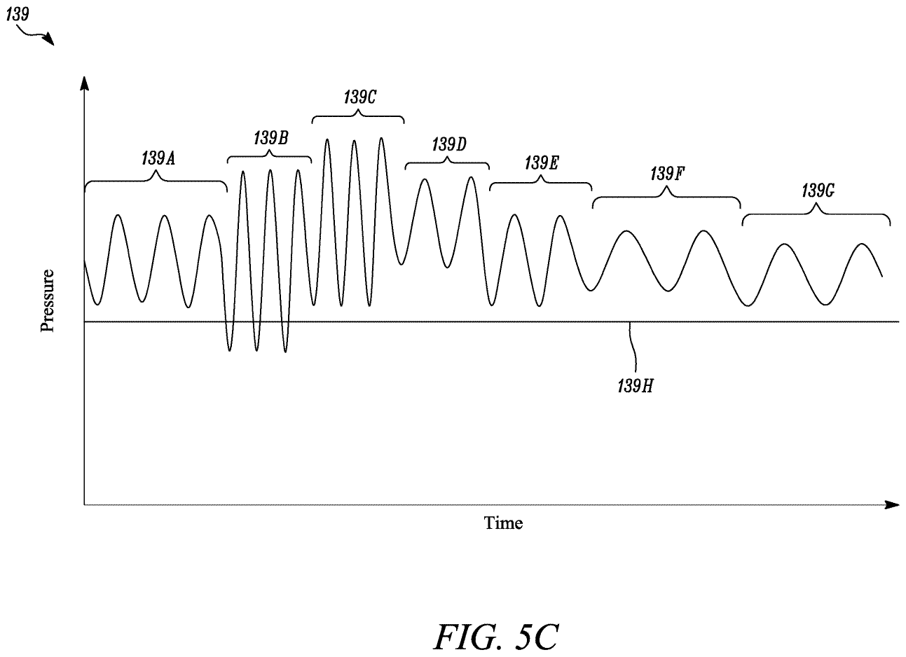

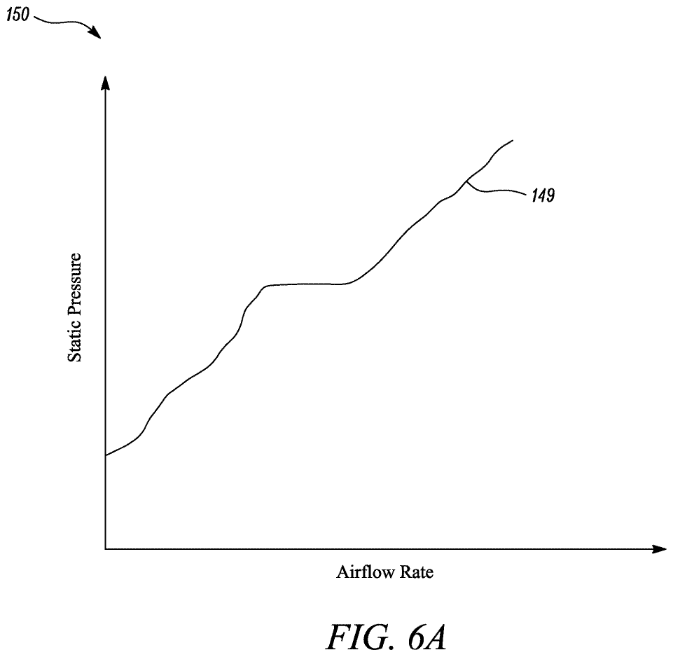

FIGS. 5A and 5B illustrate schematic block diagrams of the controller 140 of the breathing device 100 shown in FIG. 2, according to an embodiment of the present disclosure.

Referring to FIGS. 4A and 5A, in some embodiments, the controller 140 is configured to determine a first pressure difference 136 as a difference between the respiratory inlet pressure 134 and an ambient pressure level 131. In some embodiments, the ambient pressure level 131 may be based on a preset and/or a user setting stored in the memory 104A (shown in FIG. 2). In some embodiments, the user 101 (shown in FIG. 1) may select the ambient pressure level 131 via the one or more input devices 107 (shown in FIG. 2). In some embodiments, the ambient pressure level 131 may be greater than an ambient pressure. In some embodiments, the ambient pressure level 131 may be less than the ambient pressure. In some embodiments, the ambient pressure level 131 may be equal to the ambient pressure.

In the illustrated embodiment of FIG. 4A, the ambient pressure level 131 may be selected from one of first, second, and third ambient pressure levels 131A, 131B, 131C stored in the memory 104A. However, the memory 104A may store any number of ambient pressure levels based on desired application attributes.

Referring to FIGS. 4A and 5B, in some embodiments, the controller 140 is further configured to determine a second pressure difference 138 as a difference between the first pressure difference 136 and a target pressure 133. Further, in some embodiments, the controller 140 is further configured to determine the target airflow rate 142 based at least on the second pressure difference 138, such that the second pressure difference 138 is reduced. The controller 140 may determine the target airflow rate 142 based on a predetermined relationship between the target airflow rate 142 and the second pressure difference 138. The predetermined relationship may include, for example, but not limited to, a lookup table, a mathematical equation (e.g., a multiple polynomial regression model), a physics-based model, a neural network model, or any other model or algorithm known in the art.

In some embodiments, the target pressure 133 may be based on a preset and/or a user setting stored in the memory 104A (shown in FIG. 2). In some embodiments, the target pressure 133 may be adjusted in discrete or continuous increments between a predetermined minimum target pressure 152 and a predetermined maximum target pressure 154. In some embodiments, the user 101 (shown in FIG. 1) may select the target pressure 133 via the one or more input devices 107 (shown in FIG. 2).

In some embodiments, if the second pressure difference 138 is greater than or equal to the predetermined minimum target pressure 152 and less than or equal to the predetermined maximum target pressure 154, the controller 140 is further configured to set the target airflow rate 142 based on the second pressure difference 138. In other words, if the second pressure difference 138 is within a range between the predetermined minimum target pressure 152 and the predetermined maximum target pressure 154, the controller 140 is further configured to set the target airflow rate 142 based on the second pressure difference 138.

In some embodiments, if the second pressure difference 138 is less than the minimum target pressure 152 or greater than the maximum target pressure 154, the controller 140 is further configured to set the target airflow rate 142 based on the predetermined maximum target pressure 154. In other words, if the second pressure difference 138 is not within the range between the predetermined minimum target pressure 152 and the predetermined maximum target pressure 154, the controller 140 is further configured to set the target airflow rate 142 based on the predetermined maximum target pressure 154. This may ensure that the respiratory airflow 111, which is based on the target airflow rate 142, is sufficient for the user 101 (shown in FIG. 1).

In some embodiments, if the second pressure difference 138 is not within an acceptable limit after a threshold time duration, the controller 140 may generate an alarm signal.

FIG. 5C illustrates an exemplary plot 139 depicting pressure versus time for the breathing device 100 shown in FIG. 2. Specifically, the plot 139 illustrates the respiratory inlet pressure 134 versus time for the breathing device 100.

The plot 139 includes pressure regions 139A-139G corresponding to different work rates of the user 101 shown in FIG. 1. As used herein, the term “work rate” refers to a demand for the respiratory airflow 111 by the user 101 per unit time due to a workload.

The plot 139 further includes a line 139H depicting the ambient pressure level 131 (shown in FIG. 4A). The area below the line 139H depicts a negative pressure relative to the ambient pressure level 131 and the area above the line 139H depicts a positive pressure relative to the ambient pressure level 131. The line 139H corresponds to the ambient pressure level 131 or the zero pressure relative to the ambient pressure level 131.

Referring to FIGS. 4A and 5A-5C, and as is apparent from the pressure region 139B, the work rate of the user 101 increases. The controller 140 controls the airflow unit 110 based on the target airflow rate 142, such that the airflow unit 110 provides the respiratory airflow 111 at the target airflow rate 142. Further, the target airflow rate 142 is based at least on the second pressure difference 138, such that the second pressure difference 138 is reduced. The target airflow rate 142 correspondingly increases based on the work rate in the pressure region 139B. As is apparent from the pressure region 139C, the respiratory inlet pressure 134 is above the ambient pressure level 131.

Further, as is apparent from pressure region 139D, the work rate of the user 101 decreases. The controller 140 controls the airflow unit 110 based on the target airflow rate 142, such that the airflow unit 110 provides the respiratory airflow 111 at the target airflow rate 142. Further, the target airflow rate 142 is based at least on the second pressure difference 138, such that the second pressure difference 138 is reduced. The target airflow rate 142 correspondingly decreases based on the work rate in the pressure region 139D. As is apparent from the pressure region 139E, the respiratory inlet pressure 134 is closer to the ambient pressure level 131.

Similarly, as is apparent from pressure region 139F, the work rate of the user 101 further decreases. The controller 140 controls the airflow unit 110 based on the target airflow rate 142, such that the airflow unit 110 provides the respiratory airflow 111 at the target airflow rate 142. Further, the target airflow rate 142 is based at least on the second pressure difference 138, such that the second pressure difference 138 is reduced. The target airflow rate 142 correspondingly decreases based on the work rate in the pressure region 139F. As is apparent from the pressure region 139G, the respiratory inlet pressure 134 is closer the ambient pressure level 131.

As is apparent from the plot 139, the controller 140 may minimize the respiratory airflow 111 requirements to maintain the positive pressure in the respiratory inlet 122 relative to the ambient pressure level 131. Further, rapid increase or decrease in the respiratory airflow 111 may not be required to maintain the positive pressure.

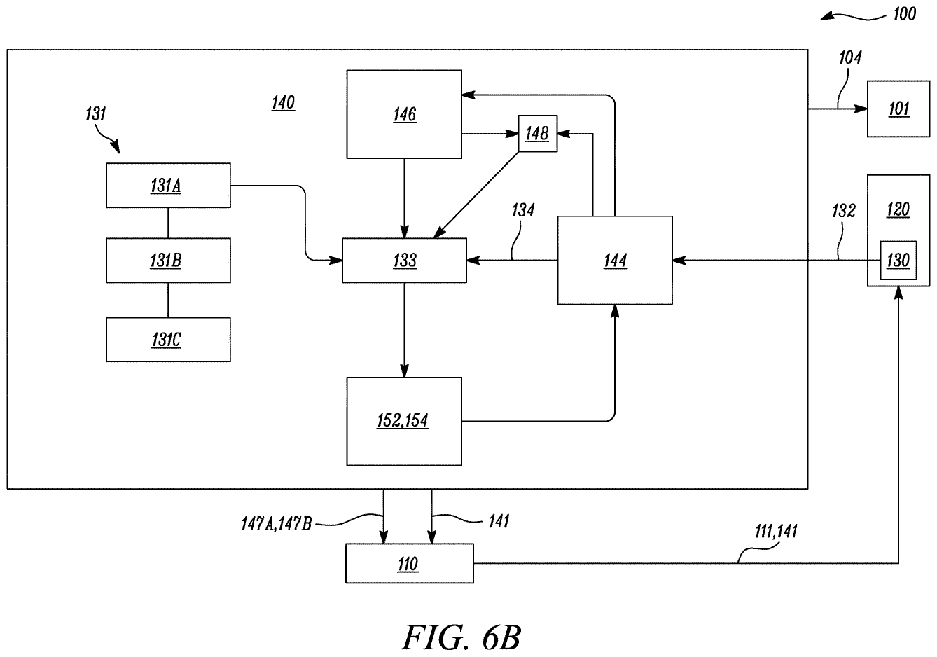

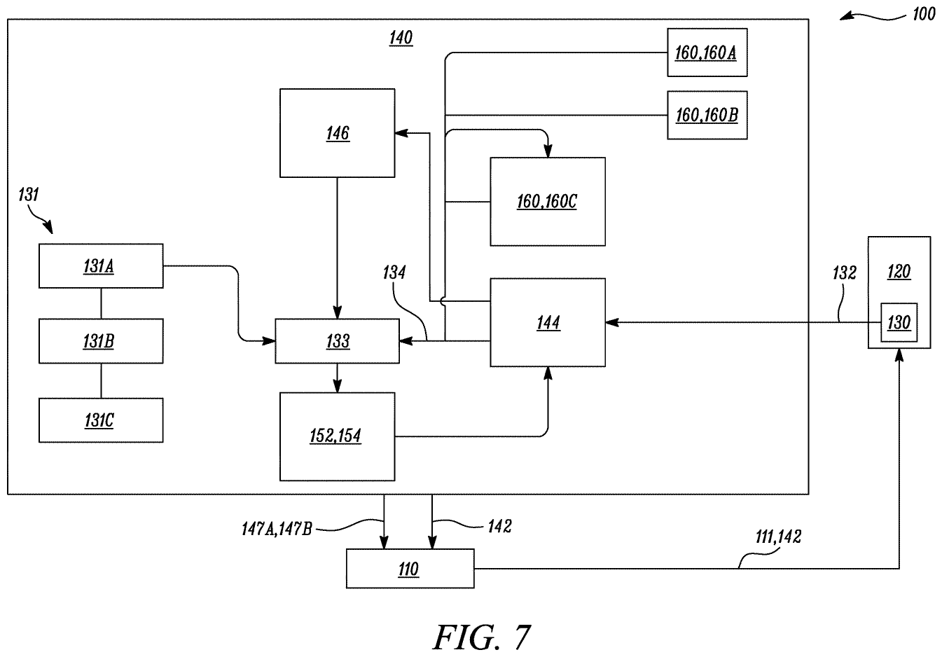

FIG. 6A illustrates an exemplary plot 150 depicting a relationship 149 between an airflow rate 141 (shown in FIG. 6B) of the airflow unit 110 shown in FIG. 1 and a static pressure 148 (shown in FIG. 6B) of the respiratory interface 120 shown in FIG. 1. The airflow rate 141 is expressed in the abscissa. The static pressure 148 is expressed in the ordinate. FIG. 6B illustrates a detailed schematic block diagram of the breathing device 100, according to an embodiment of the present disclosure.

Referring to FIGS. 6A and 6B, in some embodiments, the controller 140 is further configured to determine the static pressure 148 based on the pressure parameter 144 when the user 101 is prompted to hold breath for a predetermined time duration. Therefore, when prompted, the user 101 may not inhale or exhale for the predetermined time duration. In some embodiments, the controller 140 may generate an alert 104 to prompt the user 101. In some embodiments, the alert 104 may be a visual alert, an audible alert, and/or a haptic alert.

In some embodiments, the controller 140 is further configured to determine the relationship 149 between the airflow rate 141 of the airflow unit 110 and the static pressure 148. In some embodiments, the airflow rate 141 of the airflow unit 110 may be the predetermined airflow rate 156, a minimum flow rate of the airflow unit 110, a maximum flow rate of the airflow unit 110, or the target airflow rate 142. In some embodiments, the airflow rate 141 of the airflow unit 110 may be based on the predetermined minimum target pressure 152 or the predetermined maximum target pressure 154.

In some embodiments, the controller 140 is further configured to adjust the target pressure 133 based on the relationship 149 between the airflow rate 141 and the static pressure 148. Therefore, the static pressure 148, which may be different for different sizes of the respiratory inlet 122 for the user 101 having a specific head volume, may affect the target airflow rate 142. Therefore, the static pressure 148 may be used to adjust the target pressure 133 in order to reduce the effect of the static pressure 148 on the target airflow rate 142, which is based on the target pressure 133.

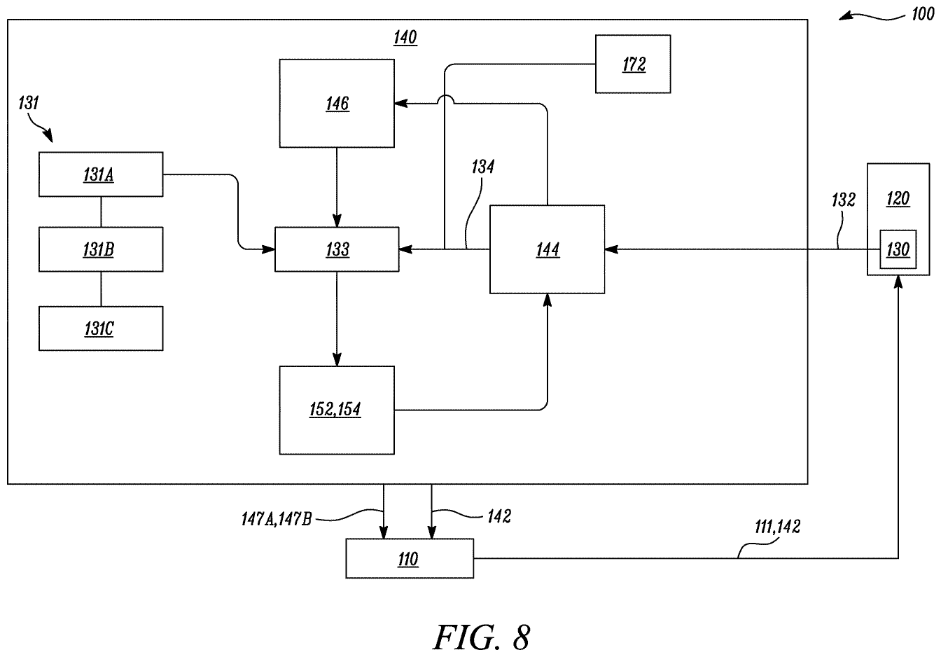

FIG. 7 illustrates a detailed schematic block diagram of the breathing device 100, according to an embodiment of the present disclosure.

In some embodiments, the controller 140 is further configured to receive at least one environmental parameter 160. In some embodiments, the controller 140 is configured to receive the at least one environmental parameter 160 in a comfort mode. In some embodiments, the comfort mode may be activated based on preset levels of the at least one environmental parameter 160. In some embodiments, the comfort mode may be activated based on the user input 108 (shown in FIG. 2) provided by the user 101 (shown in FIG. 1) via the one or more input devices 107 (shown in FIG. 2). In some embodiments, if the controller 140 does not receive the at least one environmental parameter 160 when the comfort mode is activated, the controller 140 may generate an alarm signal.

The at least one environmental parameter 160 is indicative of at least one of a temperature, a wind condition, and a humidity. Therefore, the at least one environmental parameter 160 may include a humidity parameter 160A, a wind parameter, and/or a temperature parameter 160B. In some embodiments, the temperature may be an ambient temperature. In some embodiments, the temperature may be an air temperature of the respiratory airflow 111. In some embodiments, the temperature may be a temperature inside the respiratory inlet 122. Similarly, in some embodiments, the humidity may be an ambient relative humidity. In some embodiments, the humidity may be a relative humidity of the respiratory airflow 111. In some embodiments, the humidity may be a relative humidity inside the respiratory inlet 122. In some embodiments, the wind condition may be an ambient wind condition. In some embodiments, the wind condition may be a wind condition inside the respiratory inlet 122. In some embodiments, the wind condition may be determined by one or more sensors (not shown) disposed on the breathing device 100. In some embodiments, the humidity parameter 160A, the wind parameter, and/or the temperature parameter 160B may be based on weather data/forecast.

In some embodiments, the at least one environmental parameter 160 may include a combined environmental parameter 160C based on the humidity parameter 160A, the wind condition parameter, and the temperature parameter 160B. In some embodiments, the combined environmental parameter 160C is a heat index. As used herein the term “heat index” refers to what the temperature feels like to the user 101 (shown in FIG. 1) when the humidity is combined with the temperature.

In such embodiments, the controller 140 is further configured to adjust the target airflow rate 142 further based on the at least one environmental parameter 160. The target airflow rate 142 may therefore be adjusted to provide comfort to the user 101. In some embodiments, the at least one environmental parameter 160 may be monitored to determine if an increase or a decrease in the target airflow rate 142 increases or decreases the temperature and/or the humidity and may adjust the target airflow rate 142 accordingly. In some embodiments, the target pressure 133 may be adjusted in discrete or continuous increments between the predetermined minimum target pressure 152 and the predetermined maximum target pressure 154 further based the at least one environmental parameter 160.

In some embodiments, if the at least one environmental parameter 160 is not within an acceptable limit after a threshold time duration, the controller 140 may generate an alarm signal.

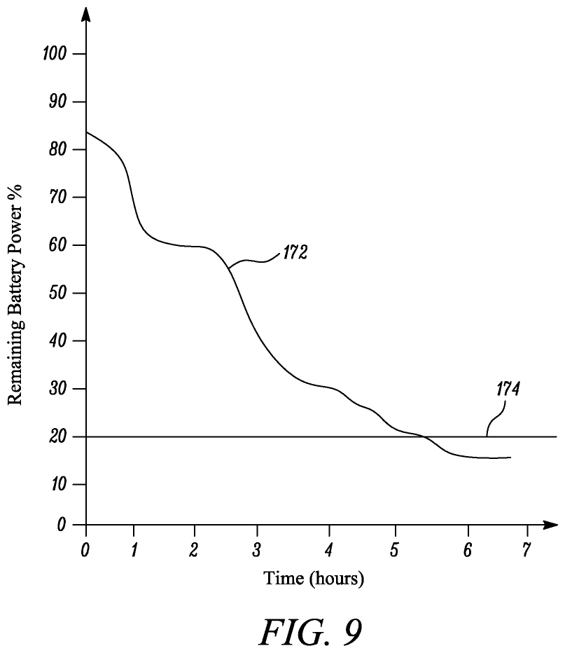

FIG. 8 illustrates a detailed schematic block diagram of the breathing device 100, according to an embodiment of the present disclosure.

In some embodiments, the controller 140 is further configured to receive at least one battery parameter 172 of the battery pack 170 shown in FIG. 2. In some embodiments, the controller 140 is configured to receive the at least one battery parameter 172 of the battery pack 170 in a battery saver mode. In some embodiments, the battery saver mode may be activated based on preset levels of the at least one battery parameter 172. In some embodiments, the battery saver mode may be activated based on the user input 108 (shown in FIG. 2) provided by the user 101 (shown in FIG. 1) via the one or more input devices 107 (shown in FIG. 2). In some embodiments, if the controller 140 does not receive the at least one battery parameter 172 when the battery saver mode is activated, the controller 140 may generate an alarm signal.

In some embodiments, the controller 140 is further configured to adjust the target airflow rate 142 further based on the at least one battery parameter 172. In some embodiments, the at least one battery parameter 172 is indicative of at least one of a remaining battery energy of the battery pack 170, a remaining battery time of the battery pack 170, a battery consumption rate of the battery pack 170, a temperature of the battery pack 170, and an age of the battery pack 170.

The target airflow rate 142 may therefore be adjusted to minimize or optimize power consumption of the battery pack 170. In other words, the electric power 171 to the airflow unit 110 may be minimized or optimized to reserve a battery capacity of the battery pack 170. As used herein, the term “battery capacity” refers to a percentage of the remaining battery energy estimated from past usage and sensor readings. In some embodiments, the target airflow rate 142 may be reduced in set intervals proportional to the remaining battery energy or the battery capacity of the battery pack 170.

In some embodiments, the target airflow rate 142 may be reduced in set intervals proportional to the remaining battery time of the battery pack 170. As used herein, the term “the remaining battery time” refers to an estimated time remaining until there is a critical level of the remaining battery energy of the battery pack 170.

In some embodiments, the target airflow rate 142 may be reduced in set intervals proportional to the battery consumption rate of the battery pack 170. As used herein, the term “the battery consumption rate” refers to a rate of change of either the remaining battery energy of the battery pack 170 or the remaining battery time of the battery pack 170.

Similarly, in some embodiments, the target airflow rate 142 may be reduced in set intervals proportional to the temperature of the battery pack 170 and/or the age of the battery pack 170.

In some embodiments, if the at least one battery parameter 172 is not within an acceptable limit after a threshold time duration, the controller 140 may generate an alarm signal.

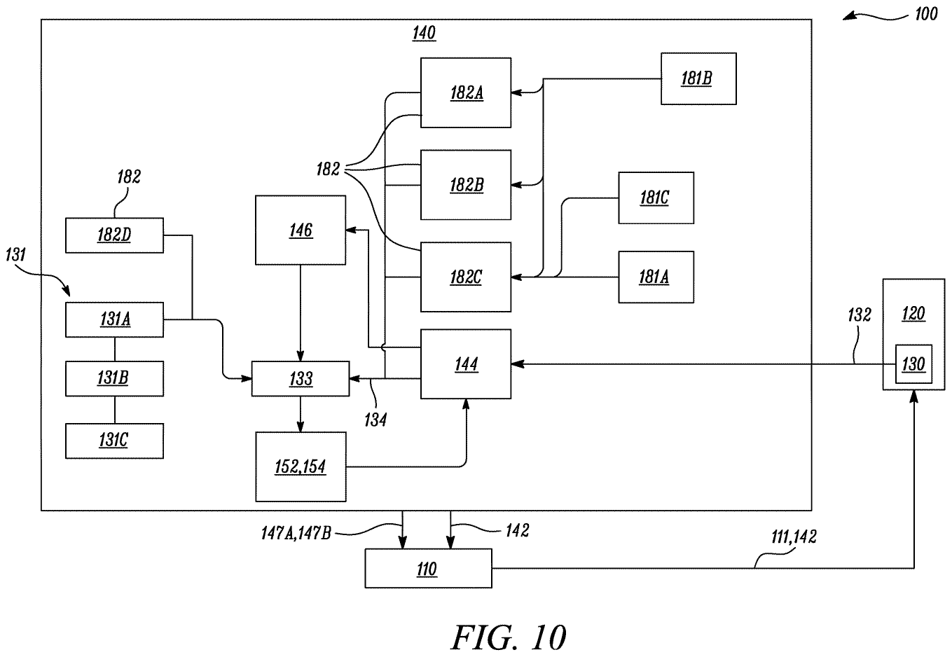

FIG. 9 illustrates an exemplary plot depicting the at least one battery parameter 172 versus time for the battery pack 170 of the breathing device 100. In the illustrated embodiment of FIG. 9, the at least one battery parameter 172 is the remaining battery energy of the battery pack 170. However, in some other embodiments, the at least one battery parameter 172 may include any other battery parameter or a combination thereof. Time is expressed in hours in the abscissa. The remaining battery energy is expressed in percentage (%) in the ordinate.

Referring to FIGS. 8 and 9, in some embodiments, the controller 140 is further configured to, if the at least one battery parameter 172 crosses a predetermined battery threshold 174 or a user-defined battery threshold, set the target airflow rate 142 based on the predetermined minimum target pressure 152. In some embodiments, the predetermined battery threshold 174 or the user-defined battery threshold may be a critical level of the at least one battery parameter 172. Therefore, the critical level may be preset or defined by the user 101 shown in FIG. 1.

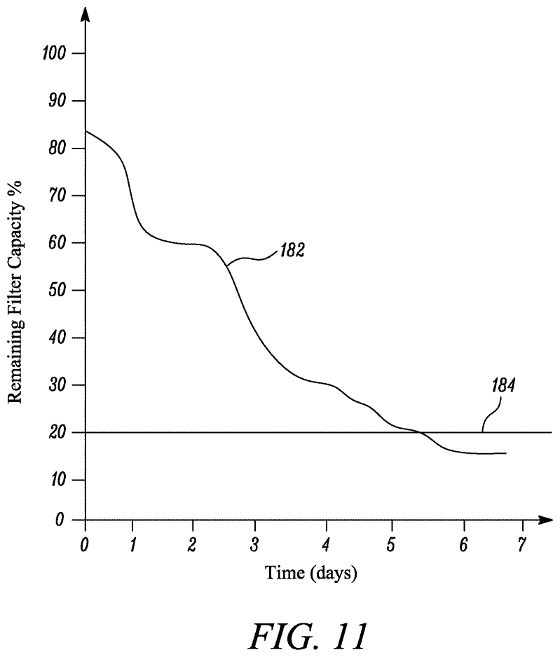

FIG. 10 illustrates a detailed schematic block diagram of the breathing device 100, according to an embodiment of the present disclosure.

In some embodiments, the controller 140 is further configured to receive at least one filter parameter 182 of the at least one filter 180 shown in FIG. 2. In some embodiments, the controller 140 is configured to receive the at least one filter parameter 182 of the at least one filter 180 in a filter saver mode. In some embodiments, the filter saver mode may be activated based on preset levels of the at least one filter parameter 182. In some embodiments, the filter saver mode may be activated based on the user input 108 (shown in FIG. 2) provided by the user 101 (shown in FIG. 1) via the one or more input devices 107 (shown in FIG. 2). In some embodiments, if the controller 140 does not receive the at least one filter parameter 182 when the filter saver mode is activated, the controller 140 may generate an alarm signal.

In some embodiments, the controller 140 is further configured to adjust the target airflow rate 142 further based on the at least one filter parameter 182. The target airflow rate 142 may therefore be adjusted to minimize or optimize filter consumption of the at least one filter 180.

In some embodiments, the at least one filter parameter 182 is indicative of at least one of a remaining filter capacity 182A of the at least one filter 180, a remaining filter service time 182B of the at least one filter 180, a target remaining filter service time 182C of the at least one filter 180, and a filter consumption rate 182D of the at least one filter 180.

In some embodiments, the target airflow rate 142 may be reduced in set intervals proportional to the remaining filter capacity 182A of the at least one filter 180. As used herein, the term “remaining filter capacity” refers to a percentage of remaining pressure for the particulate filters or remaining service life for the gas/vapor filters available in the at least one filter 180 estimated from past usage and sensor readings.

In some embodiments, the target airflow rate 142 may be reduced in set intervals proportional to the remaining filter service time 182B of the at least one filter 180. As used herein, the term “remaining filter service time” refers to an estimated time remaining until there is a critical level of the remaining filter capacity 182A of the at least one filter 180.

In some embodiments, the target airflow rate 142 may be adjusted in set intervals proportional to the target remaining filter service time 182C of the at least one filter 180. As used herein, the term “target remaining filter service time” refers to an estimated time difference from a targeted remaining filter life of the at least one filter 180. In other words, the target airflow rate 142 may be adjusted in set intervals proportional to the target remaining filter service time of the at least one filter 180 such that the targeted filter life can be achieved.

If the target filter service time can be achieved at an increased target airflow rate 142, then increased target airflow rate 142 is allowed. If the target filter service time can be achieved at a decreased target airflow rate 142, the target airflow rate 142 is deceased. The target filter service time may be preset or defined by the user 101.

In some embodiments, the target airflow rate 142 may be reduced in set intervals proportional to the filter consumption rate 182D of the at least one filter 180. As used herein, the term “the filter consumption rate” refers to a rate of change of either the remaining filter capacity 182A or the remaining filter service time 182B of the at least one filter 180.

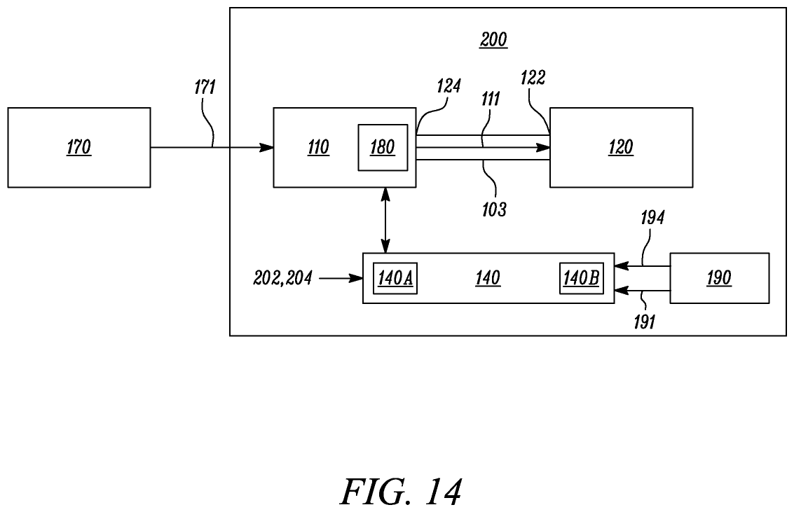

In some embodiments, the at least one filter parameter 182 may be determined based on a pressure difference 181A and an ambient pressure 181C. The pressure difference 181A is a difference between the respiratory inlet pressure 134 and an outlet pressure at the outlet 124 (shown in FIG. 1) of the airflow unit 110. In some embodiments, the outlet pressure may be determined using an outlet pressure sensor 135 (shown in FIG. 13).

The pressure difference 181A may indicate a clean pressure drop and a clogged pressure drop. In some embodiments, the at least one filter parameter 182 may be determined based on a filter identification (ID) 181B of the at least one filter 180. The filter ID 181B is unique for each filter and may be used to determine at least the service life, the filter capacity, and/or the past usage and the sensor readings of the at least one filter 180. The ambient pressure 181C, the pressure difference 181A, and/or the filter ID 181B may enable tracking and estimation of usage of the at least one filter 180.

In some embodiments, if the at least one filter parameter 182 is not within an acceptable limit after a threshold time duration, the controller 140 may generate an alarm signal.

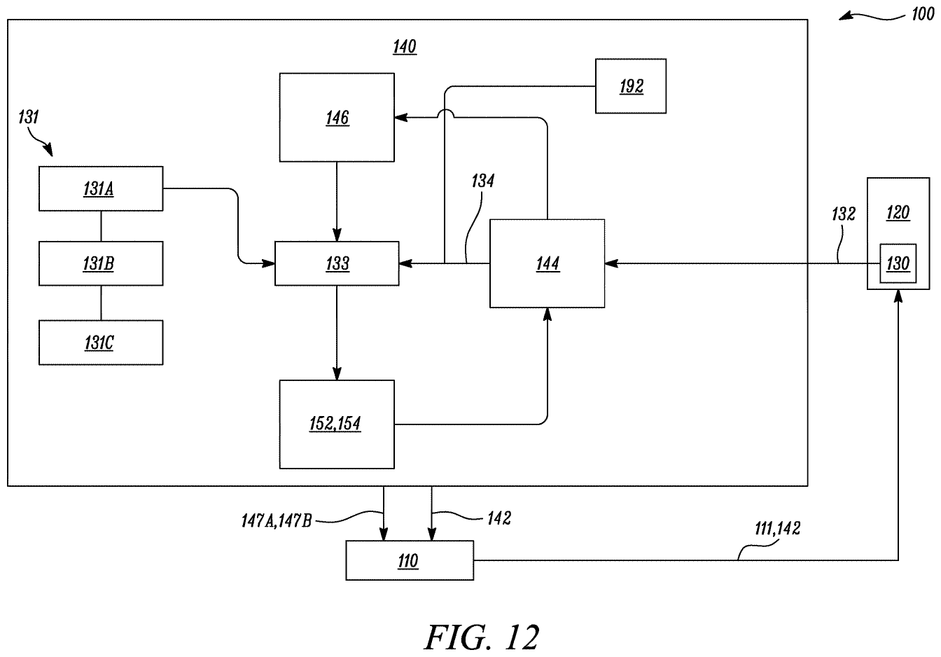

FIG. 11 is an exemplary plot depicting the at least one filter parameter 182 versus time for the at least one filter 180 of the breathing device 100. In the illustrated embodiment of FIG. 11, the at least one filter parameter 182 is the remaining filter capacity of the at least one filter 180. However, in some other embodiments, the at least one filter parameter 182 may include any other filter parameter or a combination thereof. Time is expressed in days in the abscissa. The remaining filter capacity is expressed in percentage (%) in the ordinate.

Referring to FIGS. 10 and 11, in some embodiments, the controller 140 is further configured to, if the at least one filter parameter 182 crosses a predetermined filter threshold 184 or a user-defined filter threshold, set the target airflow rate 142 based on the predetermined minimum target pressure 152. In some embodiments, the predetermined filter threshold 184 or the user-defined filter threshold may be a critical level of the at least one filter parameter 182. Therefore, the critical level may be preset or defined by the user 101 shown in FIG. 1.

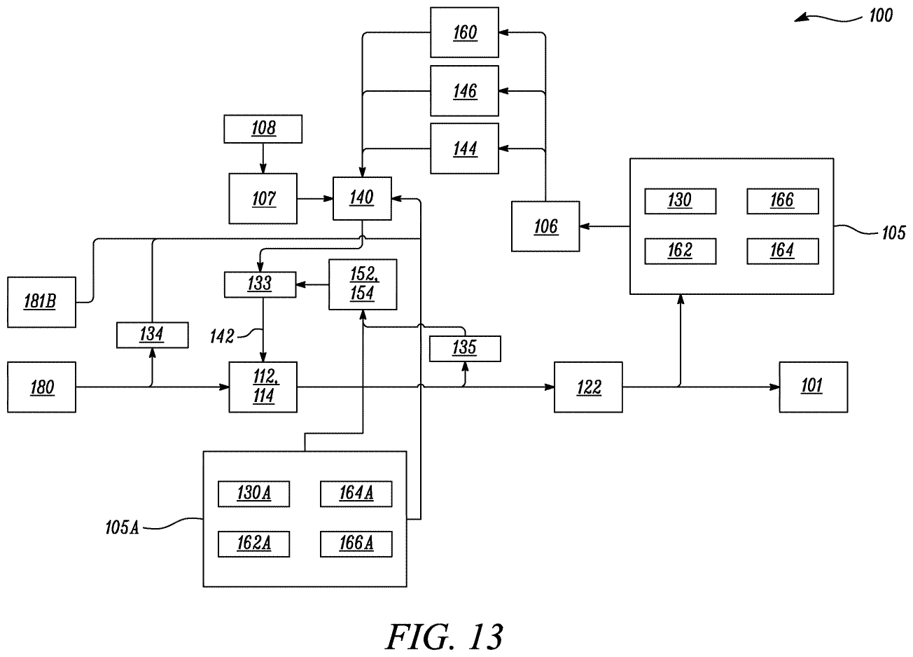

FIG. 12 illustrates a detailed schematic block diagram of the breathing device 100, according to an embodiment of the present disclosure.

In some embodiments, the controller 140 is further configured to receive a noise parameter 192. The noise parameter 192 is indicative of the noise caused by the airflow unit 110. In some embodiments, the noise parameter 192 may be determined using a sound pressure level. In some embodiments, the controller 140 is configured to receive the noise parameter 192 in a quiet mode. In some embodiments, the quiet mode may be activated based on preset levels of the noise parameter 192. In some embodiments, the quiet mode may be activated based on the user input 108 (shown in FIG. 2) provided by the user 101 (shown in FIG. 1) via the one or more input devices 107 (shown in FIG. 2).

In some embodiments, if the controller 140 does not receive the noise parameter 192 when the quiet mode is activated, the controller 140 may generate an alarm signal. In some embodiments, the controller 140 is further configured to adjust the target airflow rate 142 further based on the noise parameter 192. The target airflow rate 142 may therefore be adjusted to minimize or optimize a noise caused by the airflow unit 110. In some embodiments, the target airflow rate 142 may be adjusted in set intervals proportional to the noise parameter 192 of the at least one filter 180. In some embodiments, the target airflow rate 142 may be adjusted in set intervals proportional to the noise parameter 192.

In some embodiments, the controller 140 is further configured to receive the speech signal 194 shown in FIG. 2. Specifically, the controller 140 is further configured to receive the speech signal 194 generated by the at least one microphone 190 (shown in FIG. 2).

In some embodiments, it may be desirable to increase the target airflow rate 142 upon detecting the speech of the user 101 as the breathing rate 146 of the user 101 may increase. In such embodiments, upon receiving the speech signal 194, the controller 140 may increase the target airflow rate 142 based on the noise parameter 192. In some embodiments, the target airflow rate 142 may be increased in set intervals proportional to the noise parameter 192.

In some embodiments, it may be desirable to decrease the target airflow rate 142 upon detecting the speech of the user 101 to reduce the noise caused by the airflow unit 110. In such embodiments, upon receiving the speech signal 194, the controller 140 may decrease the target airflow rate 142 based on the noise parameter 192. In some embodiments, the target airflow rate 142 may be decreased in set intervals proportional to the noise parameter 192.

In some embodiments, if the noise parameter 192 is not within an acceptable limit after a threshold time duration, the controller 140 may generate an alarm signal.

FIG. 13 illustrates a detailed schematic block diagram of the breathing device 100, according to an embodiment of the present disclosure.

In some embodiments, the breathing device 100 includes a respiratory inlet sensor pack 105 disposed at the respiratory inlet 122. The respiratory inlet sensor pack 105 includes the at least one pressure sensor 130. Further, the respiratory inlet sensor pack 105 further includes at least one humidity sensor 162, at least one temperature sensor 164, and at least one microphone 166 (e.g., the at least one microphone 190). Signals generated by the at least one pressure sensor 130 (i.e., the at least one signal 132), the at least one humidity sensor 162, the at least one temperature sensor 164, and the at least one microphone 166 (e.g., the speech signal 194) may be provided to a data filtering unit 106. The data filtering unit 106 may process the signals from the at least one pressure sensor 130, the at least one humidity sensor 162, the at least one temperature sensor 164, and the at least one microphone 166 to generate corresponding processed signals. In some embodiments, the data filtering unit 106 may process the signals by using averaging techniques, exclusion of outliers techniques, peak identification techniques, boxcar filtering techniques, and/or any other data filtering techniques. In some embodiments, one or more of the signals and/or the processed signals of the respiratory inlet sensor pack 105 may be used to determine the pressure parameter 144, the breathing rate 146, and the at least one environmental parameter 160. In some embodiments, one or more of the signals and/or the processed signals of the respiratory inlet sensor pack 105 may further be used to determine the noise parameter 192.

In some embodiments, the breathing device 100 further includes an ambient sensor pack 105A disposed external and/or distal to the respiratory inlet 122. In some embodiments, the ambient sensor pack 105A includes at least one ambient pressure sensor 130A. Further, the respiratory inlet sensor pack 105 further includes at least one ambient humidity sensor 162A, at least one ambient temperature sensor 164A, and at least one ambient microphone 166A. In some embodiments, signals generated by the at least one ambient pressure sensor 130A, the at least one ambient humidity sensor 162A, the at least one ambient temperature sensor 164A, and the at least one ambient microphone 166A may also be provided to the data filtering unit 106. In some embodiments, one or more of the processed signals of the ambient sensor pack 105A may be provided to the controller 140. In some embodiments, one or more of the signals and/or the processed signals of the ambient sensor pack 105A may be used to determine the predetermined minimum target pressure 152 and the predetermined maximum target pressure 154.

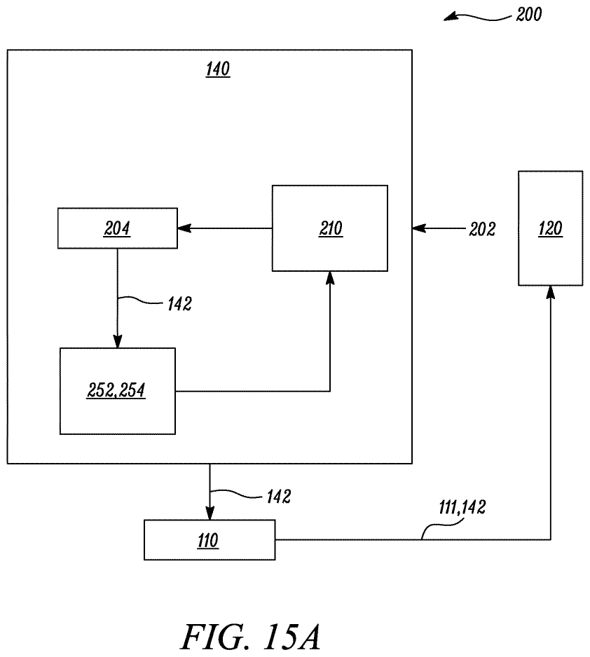

FIG. 14 illustrates a schematic block diagram of a breathing device 200, according to another embodiment of the present disclosure. The breathing device 200 is substantially similar to the breathing device 100 shown in FIG. 2, with common components being referred to by the same reference numerals.

The breathing device 200 includes the airflow unit 110, the respiratory interface 120, and the controller 140 communicably coupled to the airflow unit 110. However, the breathing device 200 does not include the at least one pressure sensor 130 (shown in FIG. 2) disposed at the respiratory inlet 122. Thus, in the illustrated embodiment of FIG. 14, the controller 140 is configured to receive at least one sensor signal 202 including at least one sensor parameter 204. In some embodiments, the controller 140 is configured to receive the at least one sensor signal 202 via the transceiver 140B. In some embodiments, the at least one sensor signal 202 may be generated by one or more sensors.

In some embodiments, the breathing device 200 includes the one or more sensors and the one or more sensors may be disposed at the respiratory inlet 122, the airflow unit 110, the battery pack 170, the at least one filter 180, and/or any other suitable locations on or proximal to the breathing device 200.

In some embodiments, the controller 140 is configured to receive the at least one sensor signal 202 from one or more external devices or remote servers (not shown) including the one or more sensors via the transceiver 140B. In some embodiments, the one or more external devices may be positioned on the user 101 shown in FIG. 1. For example, the one or more external devices may include wearable devices including the one or more sensors. In some examples, the one or more sensors may be located on a wrist or a chest of the user 101.

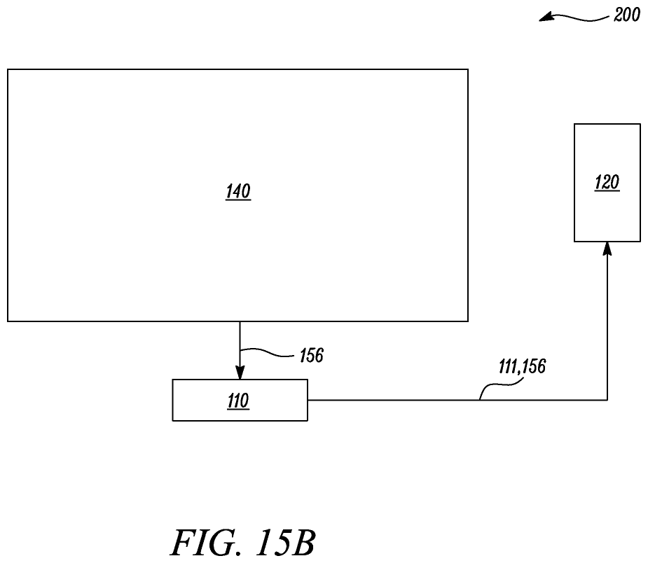

FIGS. 15A and 15B illustrate detailed schematic block diagrams of the breathing device 200, according to an embodiment of the present disclosure.

Referring to FIG. 15A, the controller 140 is configured to determine the target airflow rate 142 at least based on the at least one sensor parameter 204. As discussed above, the controller 140 is further configured to control the airflow unit 110 based on the target airflow rate 142, such that the airflow unit 110 provides the respiratory airflow 111 at the target airflow rate 142. In some embodiments, the target airflow rate 142 may be adjusted in discrete or continuous increments between a predetermined minimum airflow rate 252 and a predetermined maximum airflow rate 254. In some embodiments, the target airflow rate 142 may be preset for different increments. In some embodiments, the user 101 (shown in FIG. 1) may select the target airflow rate 142 via the one or more input devices 107 (shown in FIG. 2).

In some embodiments, the at least one sensor parameter 204 includes at least one work rate parameter 210 indicative of the work rate of the user 101 shown in FIG. 1. In some embodiments, the at least one sensor parameter 204 includes at least one physiological parameter of the user 101. In some embodiments, the at least one physiological parameter may include a heart rate, a body temperature, a blood oxygen level, chemical compositions in blood, and/or any other physiological parameter. In some embodiments, the at least one work rate parameter 210 may include at least one activity based parameter indicative of a movement of the user 101.

Referring to FIG. 15B, in some embodiments, if the controller 140 does not receive the at least one sensor signal 202, the controller 140 is further configured to control the airflow unit 110 to provide the predetermined airflow rate 156. In some embodiments, if the controller 140 does not receive the at least one sensor signal 202, the controller 140 may generate an alarm signal.

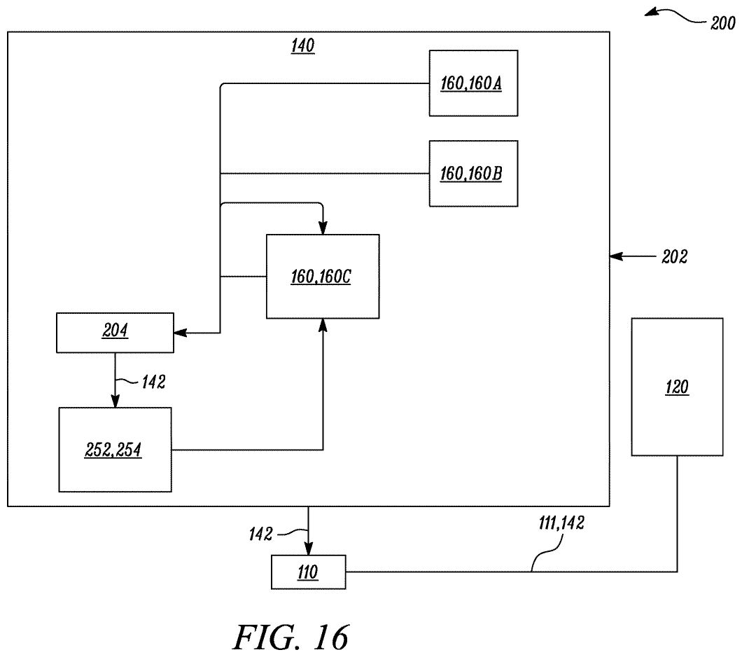

FIG. 16 illustrates a detailed schematic block diagrams of the breathing device 200, according to an embodiment of the present disclosure. In some embodiments, the at least one sensor parameter 204 includes the at least one environmental parameter 160 indicative of at least one of the temperature, the wind condition, and the humidity. Therefore, the at least one environmental parameter 160 may include the humidity parameter 160A, the wind condition parameter, and/or the temperature parameter 160B. In some embodiments, the at least one environmental parameter 160 may further include the combined environmental parameter 160C. In some embodiments, the controller 140 is configured to adjust the target airflow rate 142 further based on the at least one environmental parameter 160.

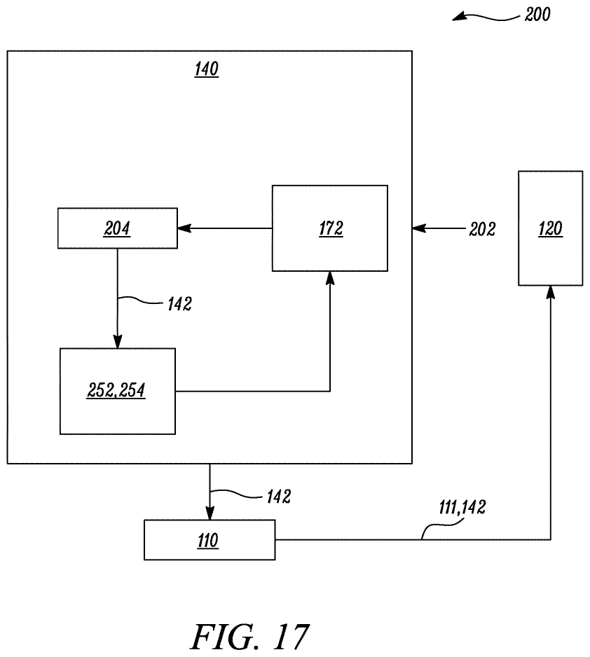

FIG. 17 illustrates a detailed schematic block diagrams of the breathing device 200, according to an embodiment of the present disclosure. In some embodiments, the at least one sensor parameter 204 includes the at least one battery parameter 172 of the battery pack 170 shown in FIG. 14. In some embodiments, the controller 140 is configured to adjust the target airflow rate 142 further based on the at least one battery parameter 172. In some embodiments, if the at least one battery parameter 172 crosses the predetermined battery threshold 174 (shown in FIG. 9) or the user-defined battery threshold, the controller 140 is configured to control the airflow unit 110 to provide the minimum airflow rate 252.

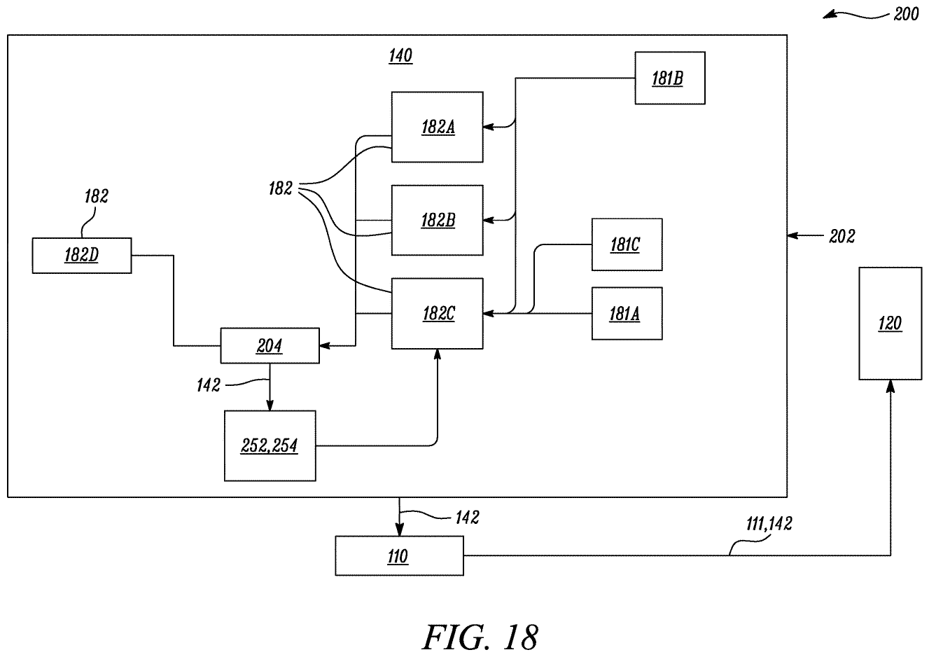

FIG. 18 illustrates a detailed schematic block diagrams of the breathing device 200, according to an embodiment of the present disclosure. In some embodiments, the at least one sensor parameter 204 includes the at least one filter parameter 182 of the at least one filter 180 shown in FIG. 14. In some embodiments, the controller 140 is configured to adjust the target airflow rate 142 further based on the at least one filter parameter 182. In some embodiments, if the at least one filter parameter 182 crosses the predetermined filter threshold 184 or the user-defined filter threshold, the controller 140 is configured to control the airflow unit 110 to provide the minimum airflow rate 252.

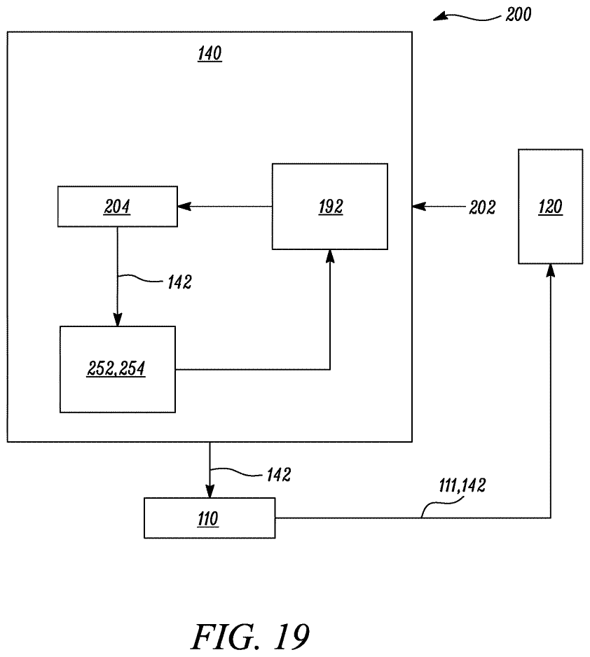

FIG. 19 illustrates a detailed schematic block diagrams of the breathing device 200, according to an embodiment of the present disclosure. In some embodiments, the at least one sensor parameter 204 includes the noise parameter 192. As discussed above, the controller 140 is configured to determine the target airflow rate 142 at least based on the noise parameter 192.

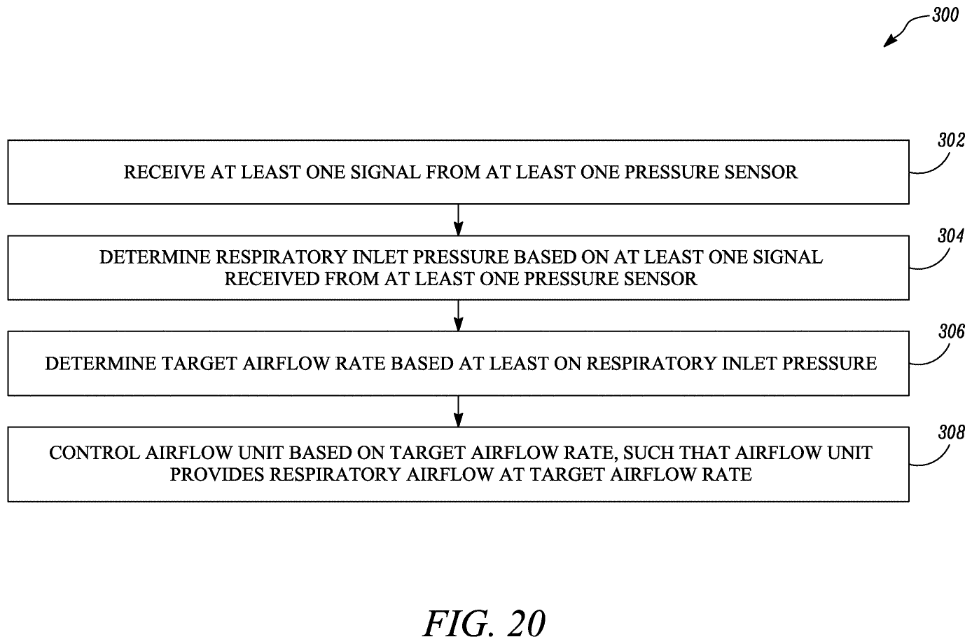

FIG. 20 illustrates a flowchart for a method 300 for controlling the airflow unit 110 of the breathing device 100 shown in FIG. 1, according to an embodiment of the present disclosure. The method 300 will be described with reference to FIGS. 1 to 13. The method 300 includes the following steps:

At step 302, the method 300 includes receiving the at least one signal 132 from the at least one pressure sensor 130 disposed at the respiratory inlet 122.

At step 304, the method 300 includes determining the respiratory inlet pressure 134 based on the at least one signal 132 received from the at least one pressure sensor 130.

In some embodiments, determining the respiratory inlet pressure 134 further includes determining the pressure parameter 144 over the predetermined time period based on the at least one signal 132. In some embodiments, determining the respiratory inlet pressure 134 further includes determining the respiratory inlet pressure 134 based on the pressure parameter 144. As discussed above, in some embodiments, the pressure parameter 144 includes one of the average pressure, the minimum peak pressure, and the maximum peak pressure.

At step 306, the method 300 includes determining the target airflow rate 142 based at least on the respiratory inlet pressure 134.

In some embodiments, determining the target airflow rate 142 further includes determining the first pressure difference 136 as the difference between the respiratory inlet pressure 134 and the ambient pressure level 131. In some embodiments, determining the target airflow rate 142 further includes determining the second pressure difference 138 as the difference between the first pressure difference 136 and the target pressure 133. In some embodiments, determining the target airflow rate 142 further includes determining the target airflow rate 142 based at least on the second pressure difference 138, such that the second pressure difference 138 is reduced.

In some embodiments, determining the target airflow rate 142 further includes setting the target airflow rate 142 based on the second pressure difference 138 if the second pressure difference 138 is greater than or equal to the predetermined minimum target pressure 152 and less than or equal to the predetermined maximum target pressure 154. In some embodiments, determining the target airflow rate 142 further includes setting the target airflow rate 142 based on the predetermined maximum target pressure 154 if the second pressure difference 138 is less than the minimum target pressure 152 or greater than the maximum target pressure 154.

In some embodiments, determining the target airflow rate 142 further includes prompting the user 101 of the breathing device 100 to hold breath for the predetermined time duration. In some embodiments, determining the target airflow rate 142 further includes determining the static pressure 148 based on the pressure parameter 144 when the user 101 of the breathing device 100 is prompted to hold breath for the predetermined time duration. In some embodiments, determining the target airflow rate 142 further includes determining the relationship 149 between the airflow rate 141 of the airflow unit 110 and the static pressure 148. In some embodiments, determining the target airflow rate 142 further includes adjusting the target pressure 133 based on the relationship 149 between the airflow rate 141 and the static pressure 148.

In some embodiments, determining the target airflow rate 142 further includes receiving the at least one environmental parameter 160. In some embodiments, determining the target airflow rate 142 further includes adjusting the target airflow rate 142 further based on the at least one environmental parameter 160.

In some embodiments, determining the target airflow rate 142 further includes receiving the at least one battery parameter 172 of the battery pack 170. In some embodiments, determining the target airflow rate 142 further includes adjusting the target airflow rate 142 further based on the at least one battery parameter 172. In some embodiments, determining the target airflow rate 142 further includes setting the target airflow rate 142 based on the predetermined minimum target pressure 152 if the at least one battery parameter 172 crosses the predetermined battery threshold 174 or the user-defined battery threshold.

In some embodiments, determining the target airflow rate 142 further includes receiving the at least one filter parameter 182 of the at least one filter 180 mounted to the airflow unit 110 and configured to filter the respiratory airflow 111. In some embodiments, determining the target airflow rate 142 further includes adjusting the target airflow rate 142 further based on the at least one filter parameter 182. In some embodiments, determining the target airflow rate 142 further includes setting the target airflow rate 142 based on the predetermined minimum target pressure 152 if the at least one filter parameter 182 crosses the predetermined filter threshold 184 or the user-defined filter threshold.

In some embodiments, determining the target airflow rate 142 further includes receiving the noise parameter 192. In some embodiments, determining the target airflow rate 142 further includes adjusting the target airflow rate 142 further based on the noise parameter 192.

In some embodiments, determining the target airflow rate 142 further includes receiving the speech signal 194 from the at least one microphone 190. In some embodiments, determining the target airflow rate 142 further includes adjusting the target airflow rate 142 based on the noise parameter 192 upon receiving the speech signal 194.

At step 308, the method 300 includes controlling the airflow unit 110 based on the target airflow rate 142, such that the airflow unit 110 provides the respiratory airflow 111 at the target airflow rate 142. In some embodiments, controlling the airflow unit 110 further includes providing the predetermined airflow rate 156 if the at least one signal 132 from the at least one pressure sensor 130 is not received.

In some embodiments, controlling the airflow unit 110 based on the target airflow rate 142 further includes controlling the at least one of the motor parameter 113 of the motor 112 and the blower parameter 115 of the blower 114 to achieve the target airflow rate 142.

In some embodiments, controlling the airflow unit 110 based on the target airflow rate 142 further includes controlling the valve parameter 119 of the valve 118 to achieve the target airflow rate 142.

In some embodiments, the method 300 further includes determining the breathing rate 146 of the user 101 of the breathing device 100 based on the pressure parameter 144. In some embodiments, the method 300 further includes switching on the airflow unit 110 upon determining that the breathing rate 146 is indicative of breathing of the user 101. In some embodiments, the method 300 further includes switching off the airflow unit 110 upon determining that the breathing rate 146 is not indicative of breathing of the user 101.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A breathing device comprising:
an airflow unit configured to provide a respiratory airflow;
a respiratory interface fluidly coupled to the airflow unit and configured to supply the respiratory airflow to a user of the breathing device, wherein the respiratory interface comprises a respiratory inlet configured to receive the respiratory airflow from the airflow unit; and
at least one pressure sensor configured to generate at least one signal, wherein the at least one pressure sensor is disposed at the respiratory inlet; and
a controller communicably coupled to each of the airflow unit and the at least one pressure sensor, the controller configured to:
receive the at least one signal from the at least one pressure sensor;
determine a respiratory inlet pressure based on the at least one signal received from the at least one pressure sensor;
determine a first pressure difference as a difference between the respiratory inlet pressure and an ambient pressure level;
determine a second pressure difference as a difference between the first pressure difference and a target pressure; and
determine a target airflow rate based at least on the second pressure difference. such that the second pressure difference is reduced; and
control the airflow unit based on the target airflow rate, such that the airflow unit provides the respiratory airflow at the target airflow rate.

2. (canceled)

3. The breathing device of claim 12, wherein controller is further configured to:
determine a pressure parameter over a predetermined time period based on the at least one signal; and
determine the respiratory inlet pressure based on the pressure parameter.

4. The breathing device of claim 3, wherein the pressure parameter comprises one of an average pressure, a minimum peak pressure, and a maximum peak pressure.

5. The breathing device of claim 3, wherein the controller is further configured to:
determine a breathing rate of the user based on the pressure parameter;
switch on the airflow unit upon determining that the breathing rate is indicative of breathing of the user; and
switch off the airflow unit upon determining that the breathing rate is not indicative of breathing of the user.

6-7. (canceled)

8. The breathing device of claim 1, wherein the controller is further configured to:
receive at least one environmental parameter, wherein the at least one environmental parameter is indicative of at least one of a temperature, a wind condition, and a humidity; and
adjust the target airflow rate further based on the at least one environmental parameter.

9. (canceled)

10. The breathing device of claim 1, wherein the controller is further configured to:
receive at least one battery parameter of a battery pack configured to provide an electric power to at least the airflow unit, wherein the at least one battery parameter is indicative of at least one of a remaining battery energy of the battery pack, a remaining battery time of the battery pack, a battery consumption rate of the battery pack, a temperature of the battery pack, and an age of the battery pack; and
adjust the target airflow rate further based on the at least one battery parameter.

11. (canceled)

12. The breathing device of claim 1 further comprising at least one filter mounted to the airflow unit, wherein the controller is further configured to:
receive at least one filter parameter, wherein the at least one filter parameter is indicative of at least one of a remaining filter capacity of the at least one filter, a remaining filter service time of the at least one filter, a target remaining filter service time of the at least one filter, and a filter consumption rate of the at least one filter; and
adjust the target airflow rate further based on the at least one filter parameter.

13-14. (canceled)

15. The breathing device of claim 1, wherein, if the controller does not receive the at least one signal from the at least one pressure sensor, the controller is further configured to control the airflow unit to provide a predetermined airflow rate.

16. The breathing device of claim 1, wherein the airflow unit comprises a motor and a blower, wherein the blower is fluidly coupled to the respiratory interface, and wherein the controller is further configured to control at least one of a motor parameter of the motor and a blower parameter of the blower to achieve the target airflow rate.

17-29. (canceled)

30. A method for controlling an airflow unit of a breathing device comprising:
receiving at least one signal from at least one pressure sensor disposed at a respiratory inlet;
determining a respiratory inlet pressure based on the at least one signal received from the at least one pressure sensor;
determining a first pressure difference as a difference between the respiratory inlet pressure and an ambient pressure level;
determining a second pressure difference as a difference between the first pressure difference and a target pressure; and
determining a target airflow rate based at least on the second pressure difference, such that the second pressure difference is reduced; and
controlling the airflow unit based on the target airflow rate, such that the airflow unit provides a respiratory airflow at the target airflow rate.

31. (canceled)

32. The method of claim 30, wherein determining the respiratory inlet pressure further comprises:
determining a pressure parameter over a predetermined time period based on the at least one signal; and
determining the respiratory inlet pressure based on the pressure parameter.

33. The method of claim 32, wherein the pressure parameter comprises one of an average pressure, a minimum peak pressure, and a maximum peak pressure.

34. The method of claim 32 further comprising:
determining a breathing rate of a user of the breathing device based on the pressure parameter;
switching on the airflow unit upon determining that the breathing rate is indicative of breathing of the user; and
switching off the airflow unit upon determining that the breathing rate is not indicative of breathing of the user.

35. The method of claim 32, wherein determining the target airflow rate further comprises:
prompting a user of the breathing device to hold breath for a predetermined time duration;
determining a static pressure based on the pressure parameter when the user of the breathing device is prompted to hold breath for the predetermined time duration;
determining a relationship between an airflow rate of the airflow unit and the static pressure; and
adjusting the target pressure based on the relationship between the airflow rate and the static pressure.

36. The method of claim 30, wherein determining the target airflow rate further comprises:
setting the target airflow rate based on the second pressure difference if the second pressure difference is greater than or equal to a predetermined minimum target pressure and less than or equal to a predetermined maximum target pressure; and
setting the target airflow rate based on the predetermined maximum target pressure if the second pressure difference is less than the minimum target pressure or greater than the maximum target pressure.

37. The method of claim 30, wherein determining the target airflow rate further comprises:
receiving at least one environmental parameter, wherein the at least one environmental parameter is indicative of at least one of a temperature, a wind condition, and a humidity; and
adjusting the target airflow rate further based on the at least one environmental parameter.

38. (canceled)

39. The method of claim 30, wherein determining the target airflow rate further comprises:
receiving at least one battery parameter of a battery pack configured to provide an electric power to at least the airflow unit, wherein the at least one battery parameter is indicative of at least one of a remaining battery energy of the battery pack, a remaining battery time of the battery pack, a battery consumption rate of the battery pack, a temperature of the battery pack, and an age of the battery pack; and
adjusting the target airflow rate further based on the at least one battery parameter.

40. (canceled)

41. The method of claim 30, wherein determining the target airflow rate further comprises:
receiving at least one filter parameter of at least one filter mounted to the airflow unit and configured to filter the respiratory airflow, wherein the at least one filter parameter is indicative of at least one of a remaining filter capacity of the at least one filter, a remaining filter service time of the at least one filter, a target remaining filter service time of the at least one filter, and a filter consumption rate of the at least one filter; and
adjusting the target airflow rate further based on the at least one filter parameter.

42-43. (canceled)

44. The method of claim 30, wherein controlling the airflow unit based on the target airflow rate further comprises providing a predetermined airflow rate if the at least one signal from the at least one pressure sensor is not received.

45. The method of claim 30, wherein controlling the airflow unit based on the target airflow rate further comprises controlling at least one of a motor parameter of a motor and a blower parameter of a blower to achieve the target airflow rate.

46. (canceled)
